(19) United States
(12) Patent Application Publication
(10) Pub. No.: US 2026/0160203 A1
(43) Pub. Date: Jun. 11, 2026

(54) ENGINE ANOMALY DETECTION AND MITIGATION SYSTEMS

(71) Applicant: Southwest Research Institute, San Antonio, TX (US)

(72) Inventors: Garrett L. ANDERSON, Seguin, TX (US); Robert MITCHELL, Boerne, TX (US); D. Ryan WILLIAMS, Boerne, TX (US)

(21) Appl. No.: 18/976,521

(22) Filed: Dec. 11, 2024

(51) Int. Cl. F02B 77/08; F02D 41/22; G01M 15/11

(52) U.S. Cl. CPC F02B 77/087; F02D 41/22; F02D 2200/0406; F02D 2200/101; F02D 2200/1015; G01M 15/11

(57) ABSTRACT

An engine anomaly detection system that includes cylinder position determination circuitry to determine a crank angle associated with one or more cylinders of the engine; intake manifold pressure determination circuitry to determine an intake manifold pressure at least during an intake stroke phase and a compression stroke phase of the one or more cylinders; and pre-ignition event detection circuitry to determine a pre-ignition event associated with the one or more cylinders based on the intake manifold pressure.

### FIELD

The present disclosure is generally directed to engine anomaly detection and mitigation systems, and, more particularly, to detection and isolation of pre-ignition events in, for example, any spark-ignited and/or duel-fuel engine. The present disclosure is also directed to mitigation strategies for pre-ignition events.

### BACKGROUND

Pre-ignition in hydrogen fueled engines is a significant problem. This pre-ignition can differ from other fuels in that it can be so advanced that the fuel is burned while the intake valve is still open. This results in a backfire in the intake manifold and an engine cycle that has pressure trace that is consistent with a misfiring engine cycle that creates no power. Detection of this combustion mode is important because it is mitigated much differently than misfire or other types of pre-ignition.

### BRIEF DESCRIPTION OF THE DRAWINGS

The above-mentioned and other features of this disclosure, and the manner of attaining them, will become more apparent and better understood by reference to the following description of embodiments described herein taken in conjunction with the accompanying drawings, wherein:

FIG. 1 illustrates a plot comparing a pre-ignition event cycle to a normal firing event cycle in an engine;

FIG. 2 illustrates a more detailed plot of a pre-ignition event in an engine, and illustrates a spike in intake manifold pressure;

FIG. 3 illustrates a block diagram of an engine anomaly detection system according to embodiments of the present disclosure;

FIG. 4 illustrates a block diagram of a mitigation system for pre-ignition and misfire events according to embodiments of the present disclosure; and

FIG. 5 illustrates a flowchart of operations to identify and mitigate engine misfire and pre-ignition events according to one embodiment of the present disclosure.

Although the following Detailed Description will proceed with reference being made to illustrative embodiments, many alternatives, modifications and variations thereof will be apparent to those skilled in the art.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

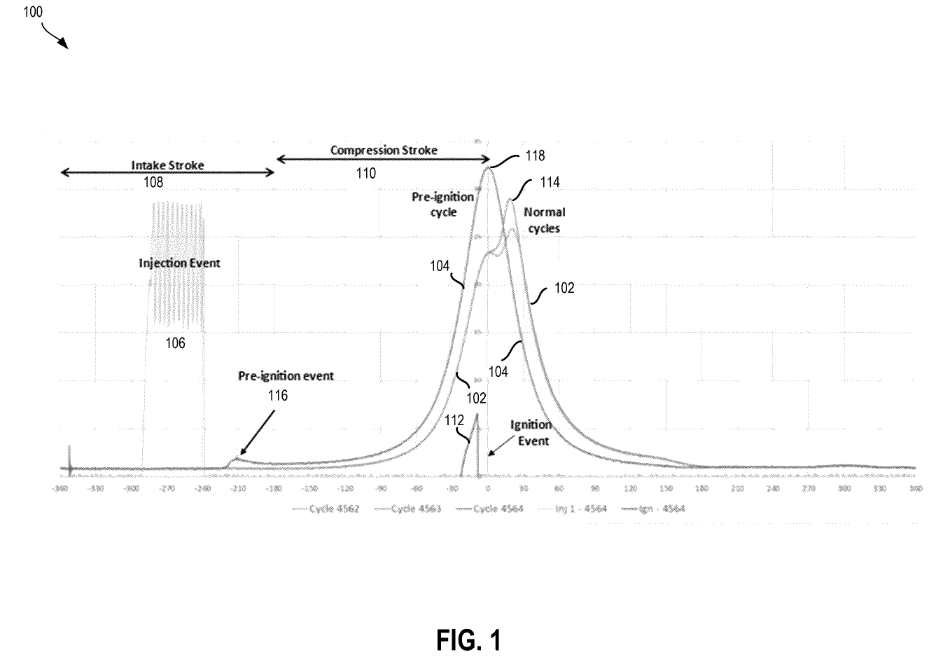

FIG. 1 illustrates a plot 100 of a pre-ignition event. In the plot 100, the x-axis represents the crank angle of a cylinder (i.e, angular rotation of the CAM shaft and crank shaft), and the y-axis represents intake manifold pressure Pim (in Bar, psi, kPa, etc.). Curve 102 illustrates a pressure response curve of a “normal” piston firing event, i.e., a piston that is firing without a pre-ignition event, and curve 104 illustrates a pressure response curve of a cylinder having a pre-ignition event. As is known, the firing sequence for a piston occurs as an injection event 106 (i.e., fuel valve(s) opening and fuel injected on top of the cylinder) during an intake stroke 108 of the cylinder. As the cylinder moves upward into the compression stroke 110, an ignition event 112 occurs and the piston is driven down, and the firing sequence repeats.

In the “normal” firing curve 102, the pressure exhibits a relatively smooth increase during the compression stroke phase 110, and peak cylinder pressure 114 occurs slightly after the ignition event 112. Comparing curve 102 to curve 104, a pre-ignition event causes a pressure spike 116 after the injection event 106, and pressure is increased during the compression stroke 110, as compared to the pressure of the normal curve 102 during the compression stroke 110. In addition, after peak pressure is achieved (at point 118, after the ignition event 112) pressure decreases rapidly, as compared to the normal curve 104. This may cause noticeable power loss and/or power fluctuations that can typically be observed by the operator of the vehicle, and may also cause engine control sensors and systems and control algorithms to detect such changes.

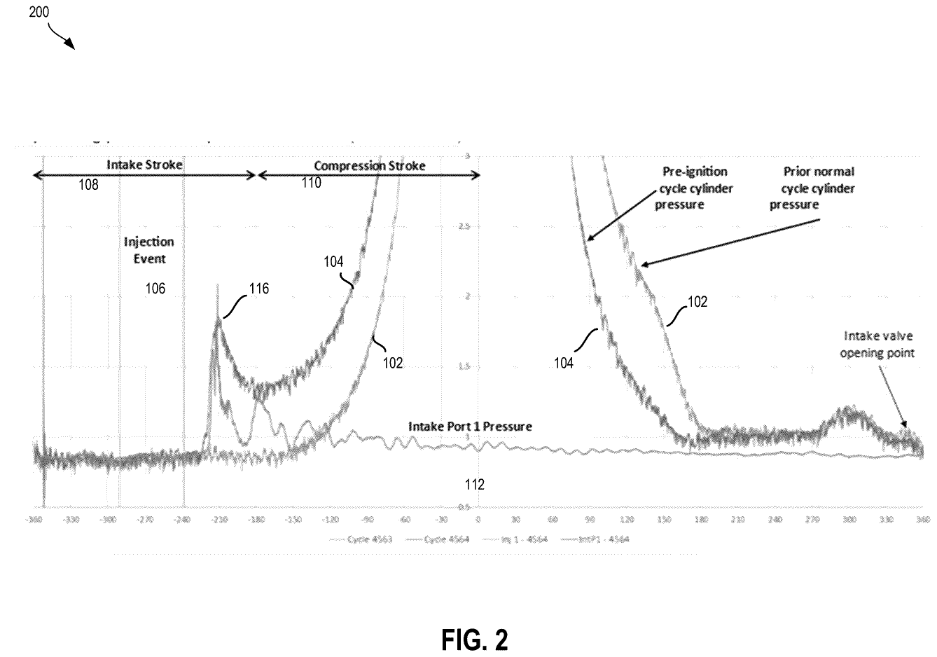

FIG. 2 illustrates a more detailed plot 200 of the pre-ignition event plot of FIG. 1. As illustrated, the pre-ignition event 116 causes an increase in intake port (intake manifold) pressure, as illustrated by the fluctuating waveform 120. Note also, as described above, pressure associated with the pre-ignition event is increased at an earlier time during the compression stroke 110 (waveform 104 compared to waveform 102), and decreased at an earlier time (waveform 104 compared to waveform 102) after the ignition event. This noticeable power loss may cause an operator to increase throttle input to maintain vehicle speed, etc.

Accordingly, the present disclosure provides systems and methods for determining pre-ignition events based on increased intake manifold pressure observed during an intake stroke and/or compression stroke phase of a firing sequence of a cylinder, as described below. It should further be noted that misfire events may also cause a reduction in engine power, however, the inventors herein have determined that a misfire event does not cause intake manifold pressure variations or, at least, does not cause intake manifold pressure variations to the extent of a pre-ignition event. Thus, the present disclosure also provides systems and methods for distinguishing between a misfire event and a pre-ignition event, as described below.

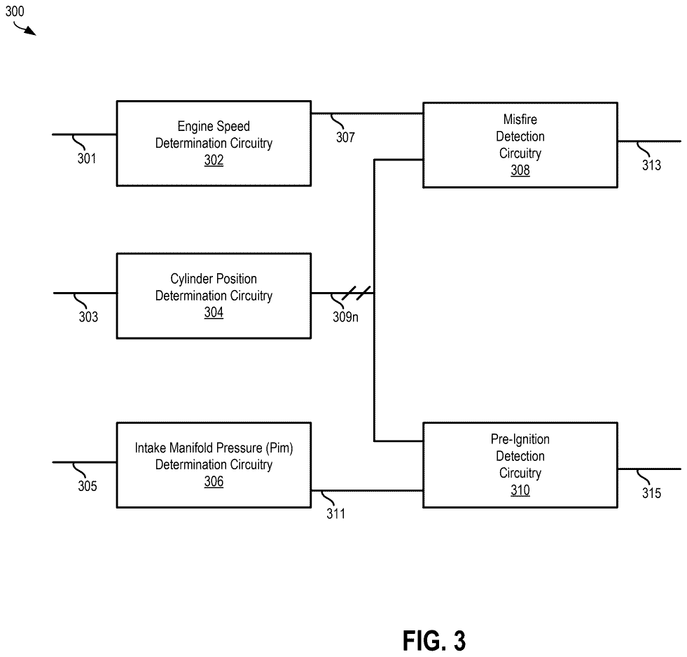

FIG. 3 illustrates a block diagram of a pre-ignition and misfire detection system 300 according to embodiments of the present disclosure. The system 300 includes engine speed determination circuitry 302, cylinder position determination circuitry 304, and intake manifold pressure determination circuitry 306. The engine speed determination circuitry 302 is generally configured to determine an engine speed, for example, in revolutions-per-minute (RPM). The engine speed determination circuitry 302 may utilize known and/or custom and/or proprietary engine speed sensor circuitry 301 and RPM sensor techniques, for example, a magnetic pickup sensor disposed on the engine flywheel (e.g., Hall effect sensor, variable reluctance senor, etc.) to determine specific locations of the flywheel, etc. In some embodiments, the engine speed determination circuitry 302 and associated engine speed sensor circuitry 301 may be configured to have a resolution (sensor response) greater than an anticipated RPM for a given engine, thus enabling granularity of sensor readings within a given rotation of the flywheel. The engine speed determination circuitry 302 may generate an engine speed signal Ve 307 (frequency signal representing engine RPM) and, for a given sensor resolution, may generate an instantaneous engine speed value.

The cylinder position determination circuitry 304 is generally configured to determine a relative position (crank angle) of a cylinder, or a plurality of cylinders, based on, for example, a rotational position of a CAM shaft controlling fuel intake and exhaust valves associated with each cylinder, as is well known. The cylinder position determination circuitry 304 may utilize known and/or custom and/or proprietary sensor circuitry 303 and cylinder position sensor techniques, for example, a magnetic pickup sensor disposed on the CAM shaft to determine rotational position of the CAM shaft to determine specific locations of the CAM shaft, etc. As is known, the crank angle position of a given cylinder is a function of the rotational position of the CAM shaft (and the crank shaft), and thus, the cylinder position determination circuitry 304 may generate a crank angle position signal of each cylinder 309n (Angle CRn), where n is the number of cylinders being controlled by a given CAM shaft. In some embodiments, the cylinder position determination circuitry 304 may be configured to have a resolution (sensor response) greater than an anticipated CAM shaft rotational speed for a given engine, thus enabling granularity of sensor readings within a given rotation of the CAM shaft.

The intake manifold pressure (Pim) determination circuitry 306 is generally configured to determine a pressure within the intake manifold of the engine. The intake manifold pressure (Pim) determination circuitry 306 may utilize known and/or custom and/or proprietary pressure sensor circuitry 305 and pressure sensor techniques, for example, a pressure sensor disposed within the intake manifold and/or downstream from the intake manifold, etc., for example, ratiometric pressure sensor(s) centrally located to measure the bulk pressure of the manifold (and to reduce the effects of other pressure waves that may be present in an engine environment). The intake manifold pressure (Pim) determination circuitry 306 may generate an intake manifold pressure (Pim) signal 311 indicative of, or proportional to, the pressure of the intake manifold of an engine. In some embodiments, the intake manifold pressure (Pim) determination circuitry 306 may be configured to have a resolution (sensor response) greater than an anticipated intake manifold pressure curve for a given engine, thus enabling granularity of sensor readings of the intake manifold pressure, and also enabling “factoring out” normal pressure variances.

The system 300 also includes misfire detection circuitry 308 generally configured to determine a misfire (or incomplete fire) event of one or more cylinders based on, at least in part, the engine speed signal Ve 307 and the crank angle position signal of each cylinder 309n. As is known, several techniques and algorithms have been developed to determine a misfire event. Accordingly, the teachings of the present disclosure may include any known, after-developed, custom and/or proprietary misfire detection techniques, and the present disclosure is not limited to any such techniques. In general, the misfire detection circuitry 308 is configured to generate a misfire event signal 313 indictive of a misfire event associated with one or more cylinders.

The system 300 also includes pre-ignition detection circuitry 310 generally configured to determine a pre-ignition event (as illustrated in FIGS. 1 and 2) based on, at least in part, the intake manifold pressure signal 311 (Pim). In some embodiments, and to provide an appropriate timing “window” of a pre-ignition event (i.e., after the injection event and during the intake stroke and/or compression stroke, as shown in FIGS. 1 and 2), the pre-ignition detection circuitry 310 may also be configured to determine a pre-ignition event based on the crank angle position signal of each cylinder 309n. Using the crank angle position signal of each cylinder 309n may also enable identification of the cylinder (or cylinders) that are experiencing the pre-ignition event. In some embodiments, and to determine if the intake manifold pressure is within normal variances, the pre-ignition detection circuitry 310 may also be configured to compare the intake manifold pressure signal 311 (Pim) to one or more pressure thresholds 317. A pressure threshold 317 may represent a pressure that is outside of a normal operating pressure variance of the intake manifold, for example, pressures greater than 10% of a “normal” operating pressure during a given engine phase may be identified as a pre-ignition event, etc. For example, pressure threshold 317 may include a median deviation of a sampled crank angle pressure, a mean deviation of a sampled crank angle pressure, and/or discrete measurements during an engine cycle, for example a measurement immediately before an expected spike and comparing to a defined threshold, etc.

To that end, one or more pressure thresholds 317 may be defined, for example, based on overall engine performance at a given engine speed, fuel/air mixture variances due to extra loading of the engine, performance at a given elevation, etc. In such embodiments, the pre-ignition detection circuitry 310 is configured to ignore intake manifold pressure readings that are below a defined threshold. In still other embodiments, a plurality of thresholds 317 may be used to define different mitigation techniques, as described below. The pre-ignition detection circuitry 310 is configured to generate a pre-ignition event signal 315 indicative or, or proportional to, a pre-ignition event associated with one or more cylinders of an engine.

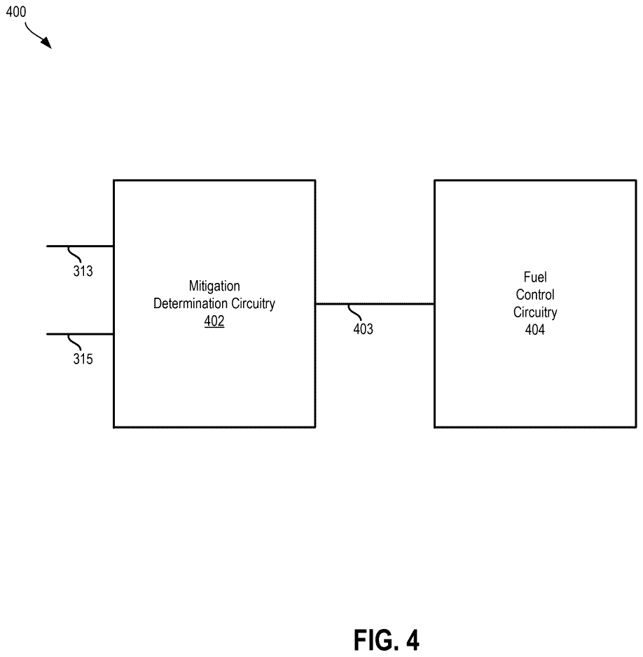

FIG. 4 illustrates a block diagram of a mitigation system 400 according to embodiments of the present disclosure. The mitigation system 400 includes mitigation control circuitry 402 generally configured to select among a misfire event 313 and/or a pre-ignition event 315. In some embodiments, the mitigation system 400 is configured to select among a misfire event 313 and/or a pre-ignition event 315 based on the crank angle position signal of each cylinder 309n, so that the cylinder(s) that is experiencing a misfire event and/or pre-ignition event is identified. The mitigation circuitry 402 is also configured to generate a mitigation control signal 403. The mitigation control signal 403 may be used, for example, the fuel control circuitry 404 associated with the engine, for example to control fuel and/or fuel air mixture for the engine as a whole, or for one or more cylinders of the engine. For example, mitigation of a misfire event may include adjusting (increasing) a fuel mixture directed to one or more identified cylinders to increase the opportunity for the cylinder(s) to fire appropriately. In contrast, a pre-ignition event may be due to an hot spot in a cylinder (or cylinders), and thus, the fuel control circuitry 404 may reduce the fuel mixture directed to one or more cylinder(s) to reduce the temperature of a given cylinder.

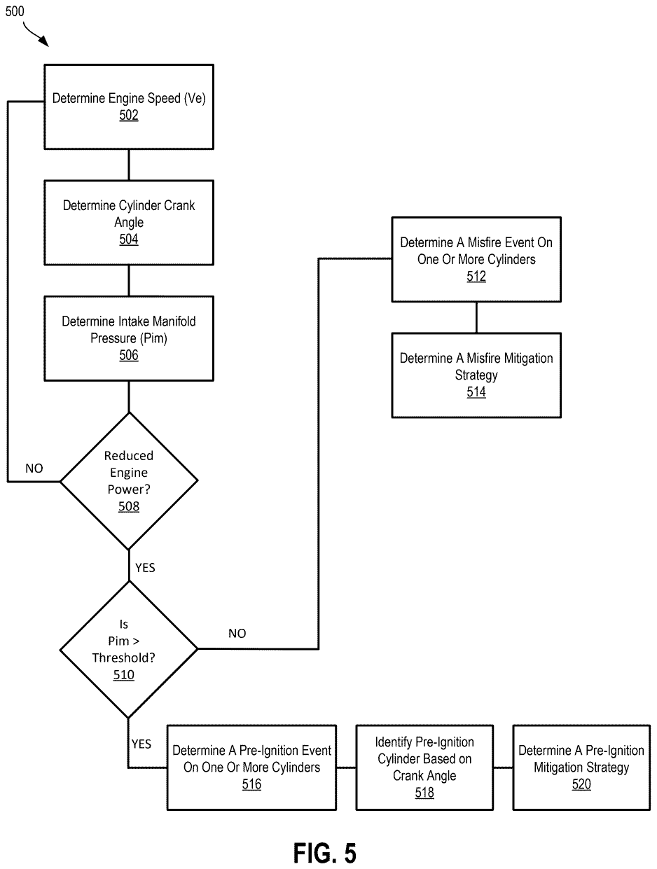

FIG. 5 illustrates a flowchart 500 of operations according to one embodiment of the present disclosure. In particular, the flowchart 500 of FIG. 5 illustrates identification of a misfire event or a pre-ignition event associated with or more cylinders of an engine, and selecting a mitigation strategy for a misfire and/or pre-ignition event. Operations of this embodiment include determining an engine speed (e.g., crank shaft RPM) 502. Operations also include determining a crank angle of one or more cylinders of the engine 504. Operations further include determining an intake manifold pressure (Pim) of the engine 506. Operations also include determining if engine power has decreased 508. Indications of reduced engine power may include, for example, increased throttle demand, reduced speed, reduced engine speed, etc. If engine power is operating within normal parameters, the process may continue by monitoring engine speed (502), crank angle (504), and Pim (506). If power has decreased (not due to driver commands or operating conditions), operations of this embodiment include determining if Pim is greater than a defined pressure threshold 510. If Pim is below a defined pressure threshold, operations further include determining a misfire event of one or more cylinders 512, and determining a mitigation strategy to resolve the misfire event 514, for example, by adjusting (e.g., increasing) a fuel/air mixture to one or more cylinders.

If Pim is defined as a defined pressure threshold (510), operations further include determining a pre-ignition event for one or more cylinders based on the increased pressure 516. In addition, a specific cylinder or cylinders experiencing a pre-ignition event may be identified based on the engine crank angle of one or more cylinders 518. Operations of this embodiment also includes determining a mitigation strategy to resolve the pre-ignition event 520, for example, by adjusting (e.g., reducing) a fuel/air mixture to one or more cylinders.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

Any of the operations described herein may be implemented in a system that includes one or more non-transitory storage devices having stored therein, individually or in combination, instructions that when executed by circuitry perform the operations. Such instructions may embodied as, for example, machine code, and/or “higher level” implementations such as software programing, application (app) programming, etc. “Circuitry”, as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The storage device includes any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device. Also, it is intended that operations described herein may be distributed across a plurality of physical devices, such as processing structures at more than one different physical location.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. An engine anomaly detection system, comprising:
cylinder position determination circuitry to determine a crank angle associated with one or more cylinders of the engine;
intake manifold pressure determination circuitry to determine an intake manifold pressure at least during an intake stroke phase and a compression stroke phase of the one or more cylinders; and
pre-ignition event detection circuitry to determine a pre-ignition event associated with the one or more cylinders based on the intake manifold pressure.

2. The system of claim 1, wherein the pre-ignition event detection circuitry further configured to determine which cylinder, from among a plurality of cylinders, is experiencing the pre-ignition event based on the crank angle of the one or more cylinders.

3. The system of claim 1, wherein the pre-ignition event detection circuitry further configured to compare the intake manifold pressure to a selected pressure threshold and determine the pre-ignition event based on the difference between the intake manifold pressure and the selected pressure threshold.

4. The system of claim 1, further comprising:
engine speed determination circuitry configured to determine a speed of the engine; and
misfire event detection circuitry to determine a misfire event associated with the one or more cylinders based on the engine speed.

5. The system of claim 4, wherein the misfire event detection circuitry further configured to determine which cylinder, from among a plurality of cylinders, is experiencing the event based on the crank angle of the one or more cylinders.

6. The system of claim 4, further comprising mitigation determination circuitry to determine at least one mitigation strategy based on the pre-ignition event and the misfire event.

7. The system of claim 6, wherein the at least one mitigation strategy comprises:
a first mitigation strategy for a pre-ignition event; wherein the mitigation determination circuitry to generate a first control signal to reduce a fuel delivered to the one or more cylinders experiencing the pre-ignition event; and
a second mitigation strategy for a misfire event; wherein the mitigation determination circuitry to generate a second control signal to increase fuel delivered to the one or more cylinders experiencing the misfire event.

8. A non-transitory storage device that includes machine-readable instructions that, when executed by one or more processors, cause the one or more processors to perform operations, comprising:
determine a crank angle associated with one or more cylinders of an engine;
determine an intake manifold pressure at least during an intake stroke phase and a compression stroke phase of the one or more cylinders; and
determine a pre-ignition event associated with the one or more cylinders based on the intake manifold pressure.

9. The non-transitory storage device of claim 8, wherein the machine-readable instructions that, when executed by one or more processors, cause the one or more processors to perform operations, further comprising:
determine which cylinder, from among a plurality of cylinders, is experiencing the pre-ignition event based on the crank angle of the one or more cylinders.

10. The non-transitory storage device of claim 8, wherein the machine-readable instructions that, when executed by one or more processors, cause the one or more processors to perform operations, further comprising:
compare the intake manifold pressure to a selected pressure threshold and determine the pre-ignition event based on the difference between the intake manifold pressure and the selected pressure threshold.

11. The non-transitory storage device of claim 8, wherein the machine-readable instructions that, when executed by one or more processors, cause the one or more processors to perform operations, further comprising:
determine a speed of the engine; and
determine a misfire event associated with the one or more cylinders based on the engine speed.

12. The non-transitory storage device of claim 11, wherein the machine-readable instructions that, when executed by one or more processors, cause the one or more processors to perform operations, further comprising:
determine which cylinder, from among a plurality of cylinders, is experiencing the event based on the crank angle of the one or more cylinders.

13. The non-transitory storage device of claim 11, wherein the machine-readable instructions that, when executed by one or more processors, cause the one or more processors to perform operations, further comprising:
determine at least one mitigation strategy based on the pre-ignition event and the misfire event.

14. The non-transitory storage device of claim 13, wherein the at least one mitigation strategy comprises:
a first mitigation strategy for a pre-ignition event; wherein the mitigation determination circuitry to generate a first control signal to reduce a fuel delivered to the one or more cylinders experiencing the pre-ignition event; and
a second mitigation strategy for a misfire event; wherein the mitigation determination circuitry to generate a second control signal to increase fuel delivered to the one or more cylinders experiencing the misfire event.

15. A method to determine and engine anomaly, comprising:
determine a crank angle associated with one or more cylinders of an engine;
determine an intake manifold pressure at least during an intake stroke phase and a compression stroke phase of the one or more cylinders; and
determine a pre-ignition event associated with the one or more cylinders based on the intake manifold pressure.

16. The method of claim 15, further comprising:
determine which cylinder, from among a plurality of cylinders, is experiencing the pre-ignition event based on the crank angle of the one or more cylinders.

17. The method of claim 15, further comprising:
compare the intake manifold pressure to a selected pressure threshold and determine the pre-ignition event based on the difference between the intake manifold pressure and the selected pressure threshold.

18. The method of claim 15, further comprising:
determine a speed of the engine; and
determine a misfire event associated with the one or more cylinders based on the engine speed.

19. The method of claim 18, further comprising:
determine which cylinder, from among a plurality of cylinders, is experiencing the event based on the crank angle of the one or more cylinders.

20. The method of claim 18, further comprising:
determine at least one mitigation strategy based on the pre-ignition event and the misfire event.

21. The method of claim 20, wherein the at least one mitigation strategy comprises:
a first mitigation strategy for a pre-ignition event; wherein the mitigation determination circuitry to generate a first control signal to reduce a fuel delivered to the one or more cylinders experiencing the pre-ignition event; and
a second mitigation strategy for a misfire event; wherein the mitigation determination circuitry to generate a second control signal to increase fuel delivered to the one or more cylinders experiencing the misfire event.
